(19) United States
(12) Patent Application Publication
(10) Pub. No.: US 2015/0140331 A1
(43) Pub. Date: May 21, 2015

(54) NANOPARTICLES AND METHOD OF MAKING NANOPARTICLES

(71) Applicant: University of Georgia Research Foundation, Inc., (US)

(72) Inventors: Tina T. Salguero, Athens, GA (US); Christopher A. Barrett, Athens, GA (US); Daniel Sexton, Athens, GA (US)

(73) Assignee: UNIVERSITY OF GEORGIA RESEARCH FOUNDATION, INC., Athens, GA (US)

(21) Appl. No.: 13/653,463

(22) Filed: Oct. 17, 2012

Related U.S. Application Data
(60) Provisional application No. 61/548,410, filed on Oct. 18, 2011.

(51) Int. Cl. C01B 35/04; C01F 5/02

(52) U.S. Cl. CPC C01B 35/04; C01F 5/02; C01P 2004/24
USPC 428/402; 423/289; 423/297; 423/263; 423/592.1; 423/636

(57) ABSTRACT

Embodiments of the present disclosure include metal boride nanoparticles, methods of making metal boride nanoparticles, methods of using metal boride nanoparticle, metal oxide nanoparticles, methods of making metal oxide nanoparticles, methods of using metal oxide nanoparticle, and the like.

### CLAIM OF PRIORITY TO RELATED APPLICATION

This application claims priority to co-pending U.S. provisional application entitled “NANOPARTICLES AND METHOD OF MAKING NANOPARTICLES” having Ser. No. 61/548,410 filed on Oct. 18, 2011, which is entirely incorporated herein by reference.

### BACKGROUND

Although there has been a large surge of interest in nanosheet materials during recent years, the majority of the focus has been on graphene and graphene oxide. However, the demand for nanosheets of much more complex needs and characteristics has triggered a new wave of synthetic procedures, which aim to meet industrial challenges faced in sectors such as energy, electronics, ceramics, and polymers.

### SUMMARY

Embodiments of the present disclosure include metal boride nanoparticles, methods of making metal boride nanoparticles, methods of using metal boride nanoparticle, metal oxide nanoparticles, methods of making metal oxide nanoparticles, methods of using metal oxide nanoparticle, and the like.

In an embodiment, a structure, among others, includes a metal boride nanostructure. In an embodiment, the metal boride nanosheet is selected from: a MgB₂ nanosheet, a ScB₂ nanosheet, a TiB₂ nanosheet, a VB₂ nanosheet, a CrB₂ nanosheet, a MnB₂ nanosheet, a YB₂ nanosheet, a ZrB₂ nanosheet, a NbB₂ nanosheet, a MoB₂ nanosheet, a HfB₂ nanosheet, a TaB₂ nanosheet, a ReB₂ nanosheet, and a RuB₂ nanosheet.

In an embodiment, a method, among others, includes: providing a bulk metal boride material; intercalating lithium ions into the bulk metal boride material; reacting the intercalated bulk metal boride material with water; and producing a metal boride nanostructure.

In an embodiment, a method, among others, includes: providing a bulk metal oxide material; intercalating lithium ions into the bulk metal oxide material; reacting the intercalated bulk metal oxide material with water; and producing a metal oxide nanostructure.

Other structures, methods, features, and advantages will be, or become, apparent to one with skill in the art upon examination of the following drawings and detailed description. It is intended that all such additional structures, systems, methods, features, and advantages be included within this description, be within the scope of the present disclosure, and be protected by the accompanying claims.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of this disclosure. The patent or application file contains at least one drawing executed in color.

Copies of this patent or patent application publication with color drawing(s) will be provided by the Office upon request and payment of the necessary fee.

FIG. 1 illustrates a photograph showing the presence of the Tyndall effect when a red laser beam meets a colloidal dispersion of MgB₂ nanosheets (light scattering from the dispersed nanomaterial makes the laser beam visible).

FIGS. 2(a)-2(c) illustrate the thin profile of the sheets, which is made apparent by TEM images. FIG. 2(a) illustrates that MgB₂ nanosheets exhibit low density contrast under the electron beam and show very defined straight edges. The image in FIG. 2(b) illustrates that larger nanosheets (>500 nm) could also be observed and often included multiple layers. The polycrystalline diffraction pattern in FIG. 2(c) highlights the crystallinity of the sheets and can be indexed to the hexagonal crystal structure of MgB₂.

FIGS. 3(a)-3(c) illustrates TEM images of embodiments of nanosheets of the present disclosure. In the image in FIG. 3(a) a dense bundle of nanosheets can be seen deposited across a lacey carbon grid. The thin profile of the monolayer sheets is contrasted by the much thicker carbon lace. The TEM image in FIG. 3(b) and the corresponding polycrystalline diffraction pattern in FIG. 3(c) highlight the crystallinity of the sheets and can be indexed to the cubic crystal structure of MgO.

FIG. 4 illustrates the X-ray diffraction (XRD) analysis collected from lithium intercalated MgB₂ starting material (black line) compared to the experimentally calculated pattern for bulk MgB₂ (blue line). The inset graph highlights the lattice displacement in the MgB₂ crystal structure due to lithium incorporation while in the liquid ammonium solution. Peaks arising from residual lithium carbonate, amide and hydroxide material are also marked as well as a small amount of magnesium oxide by-product.

FIG. 5 illustrates Boron-11 nuclear magnetic resonance (NMR) spectra of bulk (red), lithiated (green) and exfoliated (blue) MgB₂ collected at 10 kHz. The near identical peak intensities and positions highlight the stability of magnesium bonded boron at each stage of the process, attesting to the quality of the resulting nanostructured material.

FIG. 6 illustrates the magnetometry measurements of bulk (blue), lithiated (black) and exfoliated (pink) MgB₂ collected using a superconducting quantum interference device (SQUID). In each case the superconductive transition point is found to occur at 37.8 K showing the preservation of MgB₂ superconductive properties throughout the exfoliation process.

FIG. 7 illustrates the thickness mapping of MgO and MgB₂ nanosheets using energy filtered transmission electron microscopy. The thicknesses dependent information gathered from inelastic scattering of the electron beam is used in conjunction with the mean free path constancies for MgO and MgB₂ at 300 keV. Thickness values taken at multiple points for MgO nanosheets are calculated at 6-7 nm while samples of MgB₂ range from 10-25 nm.

FIGS. 8(a)-8(d) illustrate transmission electron micrographs of embodiments of nanoparticles and nanosheets of the present disclosure. FIGS. 8(a) and 8(b) show the nanoparticles produced when LaB₆ is used as the starting material. The average length and diameter of the nanorod-type structures was found to range from 10-20 and 5-7 nm, respectively. When CrB₂ was used as the starting material, large nanosheets similar to MgB₂ were observed in FIG. 8(c). The HRTEM image in FIG. 8(d) shows both single nanosheets and sheets with multiple layers within the sample.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein have discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of biology, chemistry, and the like, which are within the skill of the art.

The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by volume, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequences where this is logically possible.

It must be noted that, as used in the specification and the appended claims, the singular forms “a,” “an,” and “the” include plural referents unless the context clearly dictates otherwise. Thus, for example, reference to “a compound” includes a plurality of compounds. In this specification and in the claims that follow, reference will be made to a number of terms that shall be defined to have the following meanings unless a contrary intention is apparent.

### DEFINITIONS

The term “nanosheet” refers to a nearly “two-dimensional” material that can be several monolayers thick, but preferably a single monolayer thick, and can have lateral dimensions from hundreds of nanometers to tens of microns.

### DISCUSSION

Embodiments of the present disclosure include metal boride nanoparticles, methods of making metal boride nanoparticles, methods of using metal boride nanoparticles, metal oxide nanoparticles, methods of making metal oxide nanoparticles, methods of using metal oxide nanoparticles, and the like. Embodiments of the present disclosure have unique properties and can be used in a variety of applications. In an embodiment, the nanoparticles, in particular, metal boride nanoparticles, can have properties that allow the nanostructures to be used in hard coatings, in low-friction coatings, in superconducting films, in barrier layers for microelectronics, in hydrogen storage, as a catalyst, and the like. Additional details are provided in the Examples.

In an embodiment, the metal boride nanoparticle can be a metal diboride nanostructure (e.g., AlB₂-type structure) or a metal boride with an alternative structure such as LaBr₆. In an embodiment, the metal boride nanostructure can be a nanosheet, nanostructure (e.g., a nanosphere), or a nanowire or nanorod.

In an embodiment, the metal boride nanostructure can have an AlB₂-type structure or a related structure based on alternating hexagonal flat graphite-type or puckered boron layers. For example, the metal boride nanostructure can be: a MgB₂ nanostructure, a ScB₂ nanostructure, a TiB₂ nanostructure, a VB₂ nanostructure, a CrB₂ nanostructure, a MnB₂ nanostructure, an YB₂ nanostructure, a ZrB₂ nanostructure, a NbB₂ nanostructure, a MoB₂ nanostructure, a HfB₂ nanostructure, a TaB₂ nanostructure, a ReB₂ nanostructure, or a RuB₂ nanostructure. In particular embodiments, the nanostructure can be a nanosheet such as: a MgB₂ nanosheet, a ScB₂ nanosheet, a TiB₂ nanosheet, a VB₂ nanosheet, a CrB₂ nanosheet, a MnB₂ nanosheet, an YB₂ nanosheet, a ZrB₂ nanosheet, a NbB₂ nanosheet, a MoB₂ nanosheet, a HfB₂ nanosheet, a TaB₂ nanosheet, a ReB₂ nanosheet, or a RuB₂ nanosheet.

In an embodiment, the metal oxide nanoparticle includes the appropriate number of metals and oxygen atoms to balance the charge. In an embodiment, the metal oxide nanostructure can be a nanosheet, nanostructure (e.g., a nanosphere), or a nanowire or nanorod. In an embodiment, the metal oxide nanostructure can be selected from: a MgO nanostructure, a TiO₂ nanostructure, a V₂O₅ nanostructure, a CrO nanostructure, a HfO₂ nanostructure, and a RuO₂ nanostructure. In particular, the nanostructure can be a nanosheet such as: a MgO nanosheet, a TiO₂ nanosheet, a V₂O₅ nanosheet, a CrO nanosheet, a HfO₂ nanosheet, or a RuO₂ nanosheet.

In general, the nanostructure has at least one dimension that can be on the nanoscale (e.g., about 1 to 500 nm, about 1 to 250 nm, about 1 to 10 nm), while one or two of the other dimensions may have dimensions that are greater than the nanoscale (e.g., micrometer scale). For example, a nanosheet can have a length of about several hundred microns and can have a thickness of about 1 monolayer. In an embodiment, the nanostructure can be a nanosheet that has a thickness of about 1 to 5 monolayers or about 1 monolayer, a width of about 10 to 500 nm, and a length of about 10 nm to 100 microns.

In an embodiment, the method of forming the metal nanostructure can include the following. Initially, a bulk metal boride material (e.g., metal borides such as magnesium diboride, chromium diboride, and the like) is intercalated with ions (e.g., lithium ions). In an embodiment, the intercalation reaction can include introducing Li/NH₃ to the bulk metal boride material. In an embodiment, the reaction time can be about 8 to 48 hours, and the temperature can be about −33 and −70° C. Focusing on ammonia solutions, all of the alkali metals as well as Ca, Sr, Ba, Eu, and Y, dissolve in pure ammonia to give the characteristic blue solutions (orange-bronze in color at high concentrations). Other amines are also suitable solvents, such as methylamine and ethylamine. Then the intercalated bulk metal boride material is reacted with water to produce a metal boride nanoparticle. In an embodiment, the reaction with water includes the production of hydrogen that exfoliates the intercalated metal boride material to form nanoparticles, such as nanosheets. Additional details are provided in the Examples. It should also be noted that a similar method can be used to form metal oxide nanoparticles if the bulk metal boride material is replaced with bulk metal oxide material.

In an embodiment, the reaction flask and starting material is evacuated for 1 hour down to 20 mTorr before the synthesis commences. Next, the base of the left chamber of the flask is immersed to a depth of 5 cm in a cooling bath (about −33 to −70° C.). The flask can be filled slowly with anhydrous ammonia gas, allowing time for condensation. The final volume is approximately 10 mL and appears dark blue in color. The reaction mixture is maintained at 223 K for about 24 hours without stirring.

Upon completion of the reaction, most of the lithium-ammonia solution in the left chamber is poured into the right chamber, and the left chamber is re-submerged into the cooling bath. The ammonia solution in the right chamber is allowed to distill back into the left, thereby depositing any dissolved lithium metal into the right chamber and thus removing excess lithium from the reaction product in the left chamber. This process can be repeated multiple times (e.g., six times) in order to remove as much excess lithium as possible.

Once the metal boride nanoparticles or metal oxide nanoparticles are formed, the nanoparticles can mixed with a solvent (e.g., water, alcohols, acetone, tetrahydrofuran) at ambient temperatures, for example, to form a colloidal dispersion or suspension. In an embodiment, the as-prepared metal boride nanoparticles can be annealed under atmospheric conditions to produce metal oxide nanoparticle derivatives. In another embodiment, the as-prepared metal boride nanoparticles can be hydrothermally treated (water+heat+pressure) to produce metal oxide nanoparticle derivatives.

In another embodiment, the mixture can be used to deposit the nanoparticles onto a surface using solution-based processing methods such as dip coating, spin-coating, spray-coating, layer-by-layer deposition, combinations thereof, and the like, to form a layer of a coating. In an embodiment, the structure including the surface having the layer or coating can be used in a desired manner. In an embodiment, once the mixture is dried, the layer or coating can be removed. In an embodiment, a free-standing film or a “paper” sheet including the metal boride nanoparticles can be formed using one or more filtration methods. Additional embodiments are described in the Examples.

### EXAMPLES

Now having described the embodiments of the present disclosure, in general, the examples describe some additional embodiments of the present disclosure. While embodiments of the present disclosure are described in connection with the examples and the corresponding text and figures, there is no intent to limit embodiments of the present disclosure to these descriptions. On the contrary, the intent is to cover all alternatives, modifications, and equivalents included within the spirit and scope of embodiments of the present disclosure.

### Example 1

Embodiments of the present disclosure relate to the preparation of colloidal dispersions or suspensions of metal borides with nanosized morphologies, preferably nanosheet form.

The metal boride material can include a metal boride with a structure containing layers of boron alternating with layers of metal ions. For example, many metal diborides MB₂ exhibit the AlB₂-type structure (e.g., MgB₂, ScB₂, TiB₂, VB₂, CrB₂, MnB₂, YB₂, ZrB₂, NbB₂, MoB₂, HfB₂, and TaB₂) or related structures (e.g., ReB₂, RuB₂) based on alternating hexagonal flat graphite-type or puckered boron layers.ⁱ In these structures, the interlayer ionic interactions are weaker than the covalent bonds between boron atoms in the boron sheets. In another embodiment the metal borides can have structures other than AlB₂-type (e.g., LaB₆).

The bulk metal boride starting material can be transformed into particles with nanosized morphology via an intermediate lithium-intercalated metal boride species, which contains lithium ions inserted into the material structure. An effective way of inserting lithium ions in this manner utilizes lithium metal dissolved in liquid ammonia,ⁱⁱ although other lithium intercalation routes may be applicable (e.g., those using organo-lithium reagents).ⁱⁱⁱ

In a second step, the lithium-intercalated metal boride material is reacted with water. The water is reduced to produce hydrogen gas, which exfoliates the intercalated metal boride into its constituent nanosheets or nanoparticles.

The overall transformation can be written as:

bulk MB₂+Li/NH₃→Liₓ[MB₂] (1)

Liₓ[MB₂]+H₂O→nanosized MB₂+H₂ (2)

These reactions with metal diboride starting materials provide nanosheets, whereas the same reactions with other metal borides (e.g., LaB₆) provide differing nanosized morphologies (e.g., nanoparticles and nanorods).

By analogy to other nanosheet materials like graphene and graphene oxide, metal boride nanosheets and nanoparticles can form colloidal dispersions or suspensions in a variety of solvents at ambient conditions, sometimes aided by surfactants or other stabilizing moieties. These dispersions can be used to deposit the nanomaterials onto substrates of interest via solution-based processing methods like dip-coating, spin-coating, spray-coating, layer-by-layer deposition, etc. In addition, freestanding films or “papers” of these nanomaterials can be created by filtration methods, particularly in the case of nanosheets, which pack well on porous supports due to the tendency of nanosheets to assemble parallel to each other.

### Example A

### Nanosheets of MgB₂

Preparation of Liₓ[MgB₂]:

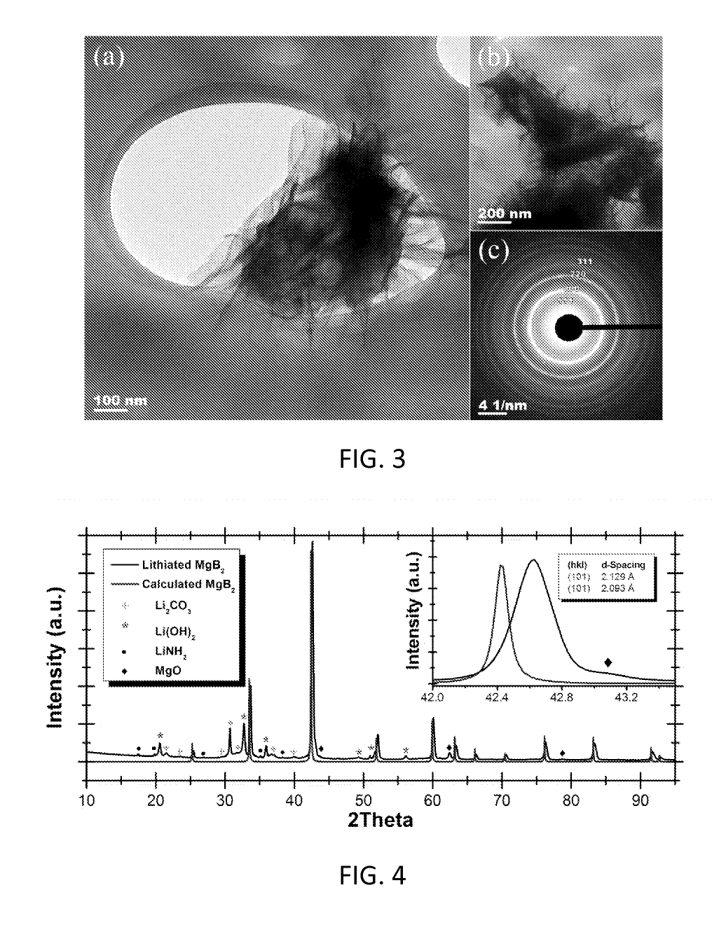

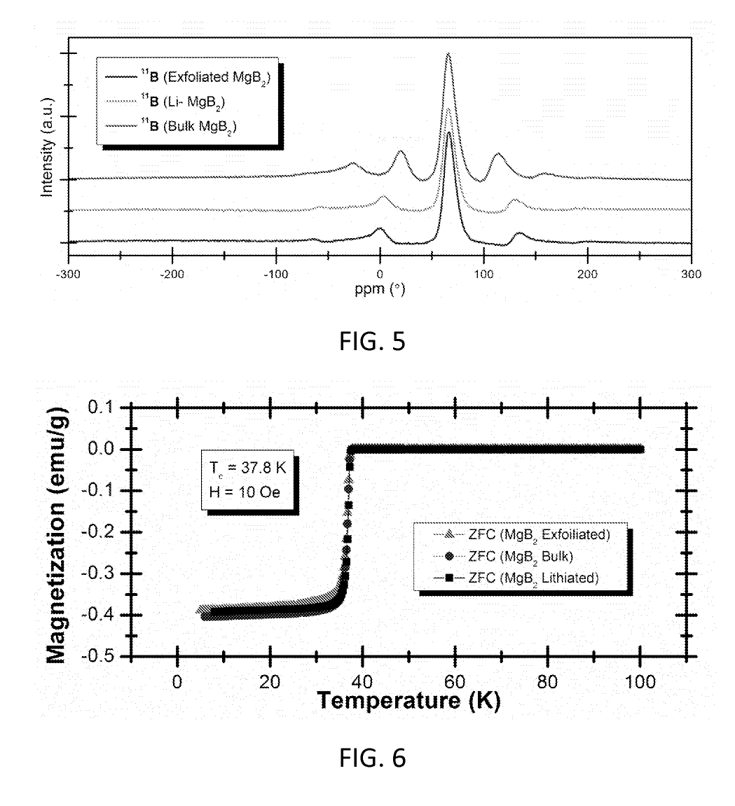

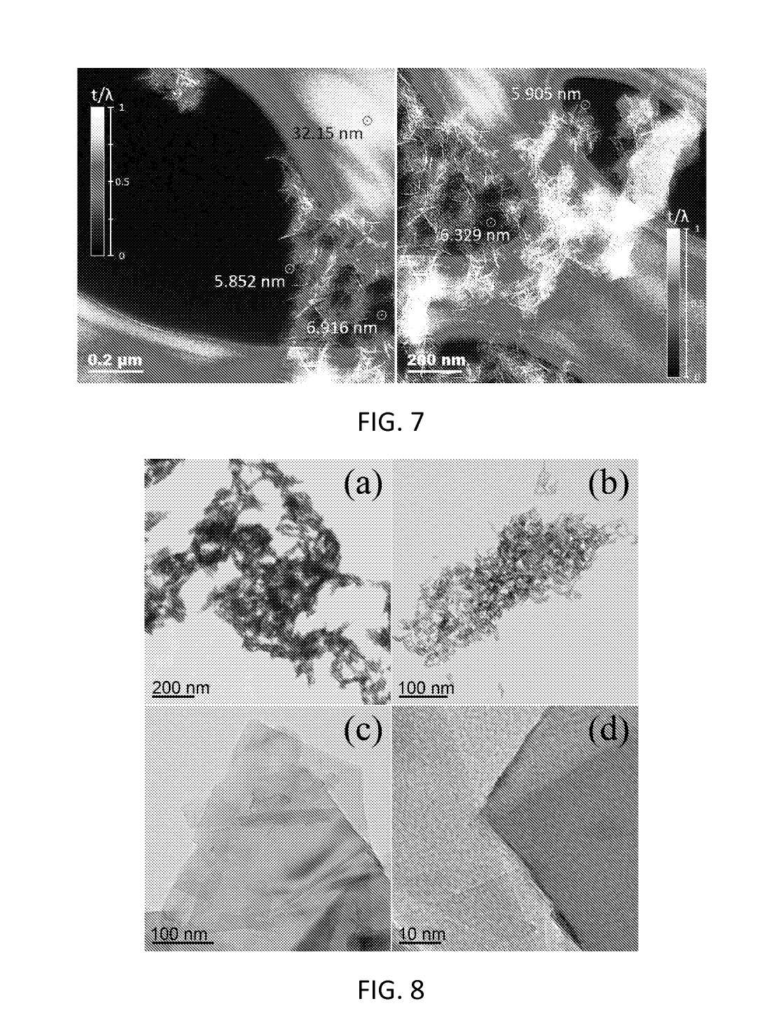

6.05 mmol of gray-brown MgB₂ powder and 8.05 mmol of lithium metal were added to the left chamber of a flask with two connected chambers. The flask was evacuated, refilled with argon gas, and re-evacuated to ensure removal of air. The base of the left chamber of the flask was immersed to a depth of 5 cm in a cooling bath of ethanol held at a constant temperature of 223 K by use of an immersion cooler. The flask was slowly filled with anhydrous ammonia gas, which condensed to a dark blue solution with a final volume of approximately 10 mL. The reaction mixture was maintained at 223 K for 24 hours without stirring. Upon completion of the reaction, most of the lithium-ammonia solution in the left chamber was poured into the right chamber, and the left chamber was re-submerged into the cooling bath. The ammonia solution in the right chamber was allowed to distill back into the left, thereby depositing any dissolved lithium metal into the right chamber and thus removing excess lithium from the reaction product. This process was repeated six times in order to remove as much excess lithium as possible. Then the flask was removed from the cooling bath and the liquid ammonia evaporated at room temperature into a flow of argon gas and passed through a bubbler containing aqueous HCl. Once all of the liquid ammonia had evaporated, the flask was evacuated overnight to remove any remaining ammonia gas. After evacuation was complete, the flask was refilled with argon, and the lithium-intercalated MgB₂ was stored in a nitrogen-filled glovebox. This gray-black powdered product Liₓ[MgB₂] was analyzed by scanning and transmission electron microscopy (see FIGS. 2, 3, 7 and 8) as well as EDS, XRD, NMR and SQUID (see FIGS. 3-6).

Preparation of MgB₂ Nanosheets and a Colloidal Dispersion of MgB₂ Nanosheets:

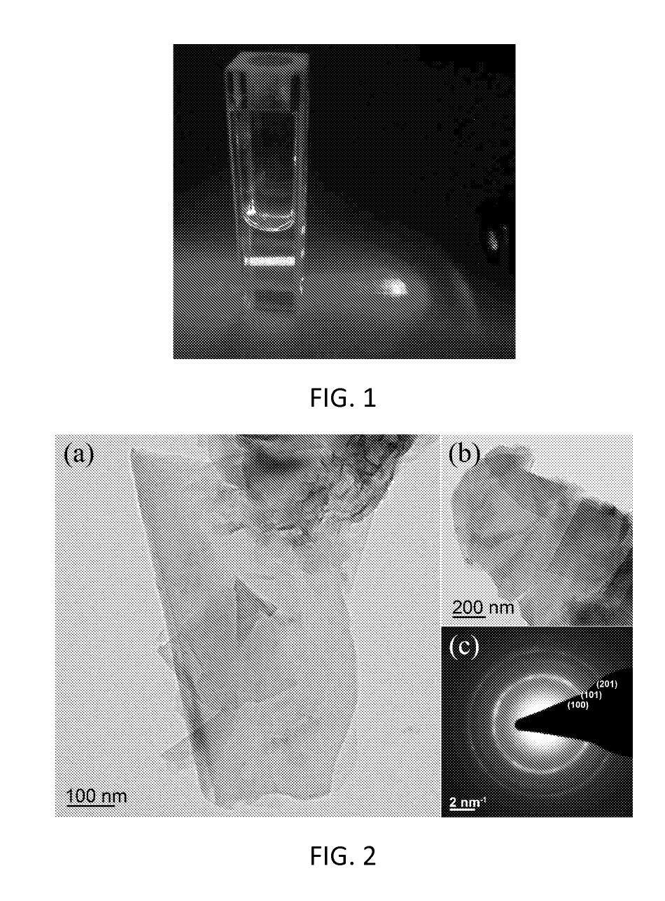

The Liₓ[MgB₂] was treated with 20 mL of purified water (Barnstead Nanopure II system) to exfoliate the layered structure. After standing for 5 minutes, the resulting suspension was centrifuged for 10 minutes at 10,000 rpm to isolate the gray-brown solid product. The resulting supernatant was decanted and the solids were re-suspended in 15 mL of purified water. This resulting suspension or colloidal dispersion, or the solid material obtained upon drying in a vacuum oven, was used for further characterization studies (see FIGS. 1-8). Initial observations indicate that MgB₂ nanosheets degrade in air, most likely because they do not contain a protective oxide layer (typically present around particles in the bulk material).

### Example B

### Nanosheets of MgO

MgB₂ nanosheets, prepared as described above, were oxidized at ambient conditions. The resulting MgO nanosheets are shown in FIG. 3.

### Example C

### Nanosheets of CrB₂

A similar synthetic procedure was used to transform CrB₂ bulk starting materials into CrB₂ nanosheets (shown in FIGS. 8(c) and 8(d)).

### Example D

### Nanoparticles of LaB₆

A similar synthetic procedure was used to transform LaB₆ bulk starting materials into LaB₆ nanoparticles (shown in FIGS. 8(a) and 8(b)).

### Some Distinguishing Features of the Present Disclosure:

### (1) the Nanosheet Morphology, a New Form for Metal Boride Materials

Metal boride in a nanosheet form has not been previously shown. Although there has been renewed interest in nanosheet materials during recent years, particularly graphene and graphene oxide, it is not obvious that metal borides, even those with the AlB₂-type structure, can be exfoliated into their constituent sheets because of the ionic bonding between layers. It also is not obvious, and is unexpected, that monolayers of metal borides would be stable and thus isolable in nanosheet form. In fact, any kind of nanosized metal boride material is difficult to make, which is indicated by limited examples in the literature.^{iv}

One previous computational study has reported that MgB₂ nanosheet structures with non-hexagonal boron sheets (i.e., containing triangular motifs) should be stable, whereas hexagonal nanosheet structures derived from bulk MgB₂ should be substantially less stable.^{v} In an embodiment, the structure of actually-prepared MgB₂ nanosheets has a hexagonal symmetry.

### (2) a Method for Producing Metal Boride Nanosheets (and Other Nanosized Metal Boride Entities as Well as Metal Oxide Nanosheets)

Importantly, intercalation chemistry has not been reported previously for boride materials. Again, although the intercalation chemistry of other materials is well known (e.g., graphite, transition metal chalcogenides), it is not obvious, and is unexpected, that metal borides would behave in the same way as materials with weak van der Waals interactions between layers. On this basis, we chose to use the most severe conditions (Li/NH₃) to intercalate lithium into metal borides. Li/NH₃ conditions have been used to intercalate lithium previously (e.g., into MoS₂,^{vi} Bi₂Te₃^{vii}), but to our knowledge, they never have been applied to boride materials.

### (3) the Solution Deposition of Metal Boride Materials Via Colloidal Dispersions of Metal Boride Nanosheets

With metal boride nanosheets in hand, colloidal dispersions or suspensions can be prepared and used for solution-based deposition. Since there were no metal boride nanosheets available prior to the present disclosure, this disclosure is also the first report of processing borides in this way. It also provides a new route to making hybrid and composite materials containing boride components.

### Applications

The metal borides exhibit a variety of outstanding properties. Many of them are good to excellent electrical and thermal conductors, have very high melting points (2000-3200° C.), have good to excellent hardness and good chemical stability.^{viii}

The practical applications of metal boride materials include specialty crucibles (e.g., for molten metals) and specialty electrodes (e.g., for the electrolytic production of aluminum).

However, the metal borides are not used as extensively as their outstanding properties might suggest, largely because of processing issues. For example, the high melting points of the metal borides make them difficult to form into desirable morphologies (e.g., thin films for coatings). Many of the borides also are brittle, which can be an issue in their processing and subsequent structural integrity.

Currently, thin films of some metal diborides can be prepared via physical vapor deposition (PVD) and chemical vapor deposition (CVD) methods [including atomic layer deposition (ALD)].^{ix} Each of these techniques has advantages and disadvantages. For example, CVD in general can produce uniform coatings on high aspect-ratio features, in contrast to PVD (which deposits material in a line-of-sight fashion). However, in practice there are a limited number of CVD precursors available for metal boride materials.

Another method of preparing surfaces incorporating metal borides is boriding, which is based on the thermal diffusion of boron atoms from a boron-rich solid, liquid, or gaseous media into the surface of a metal substrate. Boriding, however, is not used widely on an industrial scale because of its high cost, high processing temperatures, long processing time, toxic emissions/byproducts, and resulting poor surface quality.

With the disclosure of improved processing and deposition techniques, the potential applications of metal borides can be extensive. As widely noted, metal diborides (MB₂) in particular possess desirable properties for thin film applications in hard coatings, superconductor-based devices, and microelectronics.

### Surface Treatments

Embodiments of the present disclosure may be used to deposit metal boride coatings or metal boride-containing coatings as well as metal oxide coatings or metal oxide-containing coatings to enhance the properties of surfaces, such as those of engineering components, tools, or consumer products.

Several metal borides that exhibit advantageous combinations of mechanical, tribological, and chemical properties (e.g., TiB₂, ReB₂) can be used as coating materials in a large variety of industrial applications. For example:
pumping applications (e.g., shaft seals in chemical and mining industries)
rolling, rotating, or sliding applications (e.g., springs, balls, rollers, chain components, gear drives)
cutting and forming operations (e.g., metal-forming dies, forging tools, machining blades)
rocket nozzles, combustion chambers, jet engine turbines
helicopter blades, wind turbine blades
automotive engine components
in general any mechanical component that experiences heavy loads, high speeds, corrosive and/or erosive conditions, and/or oxidative media and/or elevated temperatures
medical devices such as hip and knee joints, dental implants
abrasives
substitutes for diamond or another hard material for applications involving polishing, abrasion, and/or cutting
consumer products including but not limited to watches, locks, writing instruments, bathroom equipment, jewelry, various decorative objects

These applications rely strongly on high hardness and low-friction surface properties for enhanced performance and durability, as well as protection from erosion and corrosion in certain environments. Previous work has demonstrated that metal boride coatings can achieve hardness values of up to 50 GPa (e.g., ReB₂).^{x}

In this disclosure, metal boride nanosheets and other nanosized morphologies can be deposited from colloidal dispersions or suspensions as thin films onto substrates of interest. This deposition may be conducted in a variety of ways including, but not limited to, dip-coating, spin-coating, spray-coating, layer-by-layer deposition, etc. Alternatively, the nanosized metal boride material can be dispersed within a suitable binder or matrix material or otherwise deposited on a surface according to a variety of techniques for applying particulate materials to surfaces.

In addition, the nanosized metal borides described in this disclosure can be incorporated into hybrid, composite, and/or multilayer coatings with additional material components to enhance their properties (e.g., metal components to improve elasticity properties).

### Superconducting Films

Embodiments of the present disclosure also may be used to deposit thin films or coatings of superconducting metal boride, namely magnesium diboride (MgB₂).

In general MgB₂ is used as the superconducting material in applications involving high field magnets (e.g., magnetic resonance imaging (MRI), high energy accelerators, laboratory nuclear magnetic resonance (NMR) spectroscopy) as well as electrical power (e.g., cables, motors, generators, energy storage devices).

Compared to other superconducting materials, MgB₂ is desirable because it is a simple binary, stoichiometric compound that is relatively inexpensive, lightweight, and reliable in terms of stability and safety.

There is significant interest in using MgB₂ for the fabrication of superconductor-based integrated circuits that would be capable of processing digital information faster than semiconductor-based circuits. In previous work, integrated circuits with a niobium-based superconductor demonstrated the potential to operate at clock frequencies beyond 700 GHz. However, these circuits must operate at 4.2 K, which requires heavy-duty cryocoolers that are incompatible with practical applications. In comparison, a MgB₂-based circuit could operate at 25 K, which is easily achievable by a compact cryocooler with a significantly lower mass and reduced power consumption.

Thus, thin films of MgB₂ are desirable for a variety of applications. Since the discovery of its superconductivity with high transition temperature of 39 K in 2001,^{xi} there have been extensive efforts to fabricate MgB₂ thin films.^{xii} The general method involves the reaction of elemental boron with elemental magnesium, for example the reaction of a boron thin film with magnesium vapor. However, several challenges have been encountered:
the loss of volatile Mg from MgB₂ at temperatures >400° C., which reduces its superconducting properties^{xiii}
the loss of Mg from MgB₂ via oxidation, which also reduces superconductivity
the difficulty of obtaining MgB₂ thin films with sufficient crystallinity to optimize superconductivity
the difficulty of preparing conformal films on topologically complex substrates
the difficulty in preparing MgB₂ thin films on silicon substrates because of the reaction of magnesium with silicon at elevated temperatures^{xiv}
the brittleness of MgB₂, which precludes physical processing methods that may cause cracking and thus interrupt the superconducting pathways^{xv}
the difficulty in controlling the orientation of MgB₂ layers to be parallel, not perpendicular, to the substrate in order to maximize the superconducting pathways

Accordingly, there continues to be a need for improved methods of processing MgB₂ to better utilize and benefit from its superconductivity. The present disclosure may be utilized to prepare thin films of MgB₂ via solution-based deposition of MgB₂ nanosheets. This method can overcome several of the challenges described above. For example, the preparation and deposition of MgB₂ nanosheets in this disclosure occurs at −40 to 25° C., which precludes the loss of Mg by evaporation. In addition, solution-based deposition has excellent compatibility with substrate materials, such that MgB₂ nanosheets can be deposited on silicon, oxides, polymers, etc.

A unique feature of MgB₂ nanosheets is that they are only a single monolayer thick (sub-nm). No other known method can deposit a continuous monolayer of MgB₂ over even several hundred square nanometers. This feature opens the possibility of miniaturizing MgB₂-containing components to the ultimate monolayer level.

### Barrier Layers for Microelectronics

Embodiments of the present disclosure also may be used to deposit metal boride coatings for integrated circuit fabrication, particularly as barrier layer materials.

In integrated circuits (ICs), barrier layers are used to prevent the diffusion of certain elements from one layer into another layer. Due to the current scale of semiconductor devices, this diffusion can occur readily through <100 nm layers and have a negative impact on the material properties of key components. In addition, conventional diffusion barriers can fail at elevated temperatures, effectively putting a cap on IC processing temperatures. For these reasons, barrier layers are key to state-of-the-art circuit design, and it is important to develop a variety of barrier materials to incorporate into IC structures.

Certain metal borides have been identified as potential next-generation barrier materials because of their chemical inertness, low resistivity, and excellent barrier properties at elevated temperatures.^{xvi} For example, previous work has suggested that TiB₂ should be more effective than conventional titanium nitride (TiN) or titanium tungsten (TiW) in interconnect structures to prevent the interdiffusion of copper and silicon. Thus, there is a need for processing techniques to deposit metal borides for this application.

Embodiments of the present disclosure can be used to deposit thin films of metal borides as diffusion barrier materials. During deposition from colloidal dispersions, the nanosheets have a strong tendency to stack parallel to each other, thus providing the advantage of aligned deposition. In addition, the monolayer nature of MgB₂ nanosheets means that a coating of them can be even sub-nm in thickness. No other known method can deposit a continuous monolayer of MgB₂ over even several hundred square nanometers. This feature can minimize the volume occupied by barrier layers on the IC, allowing further miniaturization. If the nanosheet is continuous and pin-hole free, the hexagonal boron sheet should be sufficient to prevent the diffusion of any elements. This concept has been demonstrated in a related system of graphene sheets, which were shown to be impermeable to air or helium gas.^{xvii}

### Additional Potential Applications:

The nanosized metal boride materials described in this disclosure may have application in a variety of other areas:
Selected metal borides have high neutron-capture cross sections due to their boron content, which makes them relevant to materials used in nuclear power plants. The present disclosure may be used to provide coatings suitable for use under these conditions.
Selected metal borides have catalytic activity for hydrogenation, hydrolysis, and hydrogen production.^{xviii} The present disclosure may provide metal boride nanosheets with enhanced catalytic activity.
Selected metal borides can be used to enhance the deposition of diamond and diamond-like carbon films on metal substrates.^{xix} The present disclosure may be used to provide coatings suitable for diamond and diamond-like carbon film deposition.
The present disclosure, particularly the intercalation of metal borides, suggests that a metal boride-based lithium ion battery may be feasible.
The present disclosure may provide metal boride materials for protective coating applications, particularly with respect to flexible electronics, including organo-based electronics
Selected metal hexaborides are noted for their field emission properties and their potential for thermoelectricity.
Selected metal borides have been used for hydrogen storage, particularly MgB₂, which can be hydrogenated to MgBH₄.^{xx} MgB₂ is particularly advantageous for this application because it is composed of light elements, which minimizes the “dead weight” of the hydrogen storage material. The present disclosure may provide MgB₂ nanosheets that can be hydrogenated under more mild conditions than bulk MgB₂ because of their nanoscale thickness and lack of oxide surface layer.

### REFERENCES

### Each of which is Incorporated by Reference

(i) Spear, K. E. “Chemical Bonding in AlB₂-Type Borides” J. Less-Common Metals 1976, 47, 195-201.
(ii) Zurek, E., et al. “A Molecular Perspective on Lithium-Ammonia Solutions” Angew. Chem. Int. Ed. 2009, 48, 8198-8232.
(iii) Dines, M. B. “Lithium Intercalation via n-Butyllithium of the Layered Transition Metal Dichalcogenides” Mat. Res. Bull. 1975, 10, 287-292.
(iv) Examples: (a) Kleine Jaeger, F., et al. “Method for preparing a suspension of nanoparticulate metal borides” U.S. patent application 2011/0180750. (b) Portehault, D., et al. “A General Solution Route toward Metal Boride Nanocyrstals” Angew. Chem. 2011, 50, 3262-3265. (c) Ma, J., et al. “A simple inorganic-solvent-thermal route to nanocrystalline niobium diboride” J. Alloys and Compounds, 2009, 468, 473-476. (d) Shi, L., et al. “Low-temperature synthesis of nanocrystalline vanadium diboride” Mat. Letters 2004, 58, 2890-2892. (e) Axelbaum, R. L., et al. “Wet Chemistry and Combustion Synthesis of Nanoparticles of TiB₂” Nanostructured Materials 1993, 2, 139-147.
(v) Tang, H. and Ismail-Beigi, S. “Self-doping in boron sheets from first principles: A route to structural design of metal boride nanostructures” Phys. Rev. B 2009, 80, 134113.
(vi) Whittingham, M. S. “Chemistry of Intercalation Compounds: Metal Guests in Chalcogenide Hosts” Prog. Solid St. Chem. 1978, 12, 41-99 and references therein.
(vii) Ding, Z., et al. “Intercalation and Solution Processing of Bismuth Telluride and Bismuth Selenide” Adv. Mater. 2001, 13, 797-800.
(viii) Matkovich, V. I. (Ed.) Boron and Refractory Borides, Springer-Verlag, 1977.
(ix) Mitterer, C. “Borides in Thin Film Technology” J. Solid State Chem. 1997, 133, 279-291
(x) (a) Kaner, R. B., et al. “Rhenium boride compounds and uses thereof” U.S. patent application 2009/0274897. (b) Chung, H.-Y., et al. “Synthesis of Ultra-Incompressible Superhard Rhenium Diboride at Ambient Pressure” Science 2007, 316, 436-439. (c) Cumberland, R. W., et al. “Osmium Diboride, An Ultra-Incompressible, Hard Material” J. Am. Chem. Soc. 2005, 127, 7264-7265.
(xi) Nagamatsu, J., et al. “Superconductivity at 39K in magnesium diboride” Nature 2001, 410, 63-64.
(xii) Examples: (a) Vijayaragavan, K. S., et al. “Electroless deposition of superconducting MgB₂ films on various substrates” Thin Solid Films 2010, 519, 658-661. (b) Wang, Y., et al. “Ultrathin epitaxial MgB₂ superconducting films with high critical current density and T_{c} above 33K” Supercond. Sci. Technol 2009, 22, 125015. (c) Zheng, X., et al. “Method for Producing Boride Thin Films” U.S. Pat. No. 6,797,341. (d) Zheng, X., et al. “In situ epitaxial MgB₂ thin films for superconducting electronics” Nature Materials 2002, 1, 1-4.
(xiii) Zhigadlo, N. D., et al. “Influence of Mg deficiency on crystal structure and superconducting properties in MgB₂ single crystals” Phys. Rev. B 2010, 81, 054520. (xiv) He, T., et al. “Reactivity of MgB₂ with common substrate and electronic materials” Appl. Phys. Lett., 2002, 80, 291-293.
(xv) Brzea, C., et al. “Review of superconducting properties of MgB₂” Superconductors, Science and Technology 2001, 14, R115-R146.
(xvi) (a) Girolami, G. S., et al. “Metal Complex Compositions and Methods for Making Metal-Containing Films” U.S. patent application 2010/0168404. (b) DeBoer, S. J., et al. “Fabrication of Semiconductor Devices with Transition Metal Boride Films as Diffusion Barriers” U.S. Pat. No. 6,872,639. (c) Jayaraman, S., et al. “Chromium diboride thin films by low temperature chemical vapor deposition” J. Vac. Sci. Technol. A 2005, 23, 631-633. (d) Sung, J. W, et al. “Remote-plasma chemical vapor deposition of conformal ZrB₂ films at low temperature: A promising diffusion barrier for ultralarge scale integrated electronics” J. Appl. Phys. 2002, 91, 3904-3911. (e) Choi, C. S., et al., “Electrical Characteristics of TiB₂ for ULSI Applications,” IEEE Transactions on Electron Devices, 1992, 2341-2345. (f) Jensen, J. A., et al. “Titanium, Zirconium, and Hafnium Tetrahydroborates as “Tailored” CVD Precursors for Metal Diboride Thin Films” J. Am. Chem. Soc. 1988, 110, 1643-1644.
(xvii) Bunch, J. S., et al. “Impermeable Atomic Membranes from Graphene Sheets” Nano Letters, 2008, 8, 2458-2462.
(xviii) (a) Patel, N., et al. “Structured and Nanoparticle Assembled Co—B Thin Films Prepared by Pulsed Laser Deposition: A Very Efficient Catalyst for Hydrogen Production” J. Phys. Chem. C 2008, 112, 6968-6976. (b) Chen, L.-F., et al. “Effect of Additive (W, Mo, and Ru) on Ni—B Amorphous Alloy Catalyst in Hydrogenation of p-Chloronitrobenzene” Ind. Eng. Chem. Res. 2006, 45, 8866-8873.
(xix) Buijinsters, J. G., et al. “Diffusion-modified boride interlayers for chemical vapor deposition of low-residual-stress diamond films on steel substrates” Thin Solid Films 2003, 426, 85-93.
(xx) Severa, G., et al. “Direct hydrogenation of magnesium boride to magnesium borohydride: demonstration of >11 weight percent reversible hydrogen storage” ChemComm 2010, 46, 421-423.

It should be noted that ratios, concentrations, amounts, dimensions, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a range of “about 0.1% to about 5%” should be interpreted to include not only the explicitly recited range of about 0.1% to about 5%, but also include individual ranges (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to the numerical value and measurement technique. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

We claim the following:

1. A structure comprising:
a metal boride nanostructure.

2. The structure of claim 1, wherein the nanostructure is a nanosheet and is about 1 to 5 monolayers thick.

3. The structure of claim 2, wherein the metal boride nanosheet is selected from: a MgB₂ nanosheet, a ScB₂ nanosheet, a TiB₂ nanosheet, a VB₂ nanosheet, a CrB₂ nanosheet, a MnB₂ nanosheet, a YB₂ nanosheet, a ZrB₂ nanosheet, a NbB₂ nanosheet, a MoB₂ nanosheet, a HfB₂ nanosheet, a TaB₂ nanosheet, a ReB₂ nanosheet, and a RuB₂ nanosheet.

4. The structure of claim 1, wherein the nanostructure is a nanosheet and is about 1 monolayer thick.

5. The structure of claim 2, wherein the nanosheet has a width of about 10 to 500 nm and a length of about 10 nm to 100 microns.

6. The structure of claim 1, wherein the metal boride is LaBr₆.

7. A method comprising:
providing a bulk metal boride material;
intercalating lithium ions into the bulk metal boride material;
reacting the intercalated bulk metal boride material with water; and
producing a metal boride nanostructure.

8. The method of claim 7, wherein intercalating includes introducing Li/NH₃ to the bulk metal boride material.

9. The method of claim 7, wherein the nanostructure is a nanosheet and is about 1 to 5 monolayers thick.

10. The method of claim 9, wherein the metal boride nanosheet is selected from: a MgB₂ nanosheet, a ScB₂ nanosheet, a TiB₂ nanosheet, a VB₂ nanosheet, a CrB₂ nanosheet, a MnB₂ nanosheet, a YB₂ nanosheet, a ZrB₂ nanosheet, a NbB₂ nanosheet, a MoB₂ nanosheet, a HfB₂ nanosheet, a TaB₂ nanosheet, a ReB₂ nanosheet, and a RuB₂ nanosheet.

11. The method of claim 10, wherein the nanosheet and is about 1 monolayer thick.

12. The method of claim 9, wherein the nanosheet has a width of about 10 to 500 nm and a length of about 10 nm to 100 microns.

13. The method of claim 8, wherein the metal boride is LaB₆.

14. The method of claim 8, wherein reacting includes exfoliating the intercalated metal boride material to form nanoparticles.

15. A method comprising:
providing a bulk metal oxide material;
intercalating lithium ions into the bulk metal oxide material;
reacting the intercalated bulk metal oxide material with water; and
producing a metal oxide nanostructure.

16. The method of claim 15, wherein intercalating includes introducing Li/NH₃ to the bulk metal oxide material.

17. The method of claim 15, wherein the nanostructure is a nanosheet and is about 1 to 5 monolayers thick.

18. The method of claim 15, wherein the metal boride nanosheet is selected from: a MgO nanosheet, a TiO₂ nanosheet, a V₂O₅ nanosheet, a CrO nanosheet, a HfO₂ nanosheet, and a RuO₂ nanosheet.

19. The method of claim 18, wherein the nanosheet and is about 1 monolayer thick.

20. The method of claim 19, wherein the nanosheet has a width of about 10 to 500 nm and a length of about 10 nm to 100 microns.

21. The method of claim 15, wherein reacting includes exfoliating the intercalated metal oxide material to form nanoparticles.
